(19) United States
(12) Patent Application Publication
(10) Pub. No.: US 2013/0268876 A1
(43) Pub. Date: Oct. 10, 2013

(54) METHOD AND APPARATUS FOR CONTROLLING MENUS IN MEDIA DEVICE

(71) Applicant: SAMSUNG ELECTRONICS CO. LTD., Suwon-si (KR)

(72) Inventors: Sie-Joon CHO, Seoul (KR); Suck-Ho SEO, Suwon-si (KR); Hye-Jung YANG, Busan (KR); Kyung-Soo LIM, Hwaseong-si (KR); Eun-Hee RHIM, Yongin-si (KR); Jin-Ha JUN, Seoul (KR)

(73) Assignee: Samsung Electronics Co., Ltd., Suwon-si (KR)

(21) Appl. No.: 13/856,096

(22) Filed: Apr. 3, 2013

(30) Foreign Application Priority Data
Apr. 4, 2012 (KR) 10-2012-0035159

(51) Int. Cl. G06F 3/0482

(52) U.S. Cl. CPC G06F 3/0482
USPC 715/769

(57) ABSTRACT

A method and an apparatus for controlling a menu in a media device are provided. If a first icon in a first icon group including at least one icon is pressed, the media device changes display status of remaining icons in the first icon group except for the first icon, and displays, in a set display area, a second icon group including at least one icon related to a function corresponding to the first icon. If a second icon in the second icon group is selected due to a drag of the first icon, which is performed while the first icon is pressed, the media device performs a function corresponding to the second icon, making it possible to easily control menus of the media device.

### PRIORITY

This application claims the benefit under 35 U.S.C. §119(a) of a Korean patent application filed in the Korean Intellectual Property Office on Apr. 4, 2012 and assigned Serial No. 10-2012-0035159, the entire disclosure of which is hereby incorporated by reference.

### BACKGROUND OF THE INVENTION

1. Field of the Invention

The present invention relates to a method and apparatus for controlling menus in a media device. More particularly, the present invention relates to a method and apparatus for controlling menus using a graphical user interface.

2. Description of the Related Art

Recently, with the development of information and communication technologies, the use of various media devices such as smart phones has increased. These media devices tend to incorporate a touch screen based on its ease of use and simple design.

Furthermore, the media devices are equipped with a variety of functions due to the prevalence of applications which have been developed thanks to the versatility of software platforms.

To perform these various functions, the media devices provide a plurality of menus in the form of an icon. When a user wants to perform a specific function, he/she needs to find and select a desired menu one by one. If the selected menu does not have the function the user wants to use, he/she should move to an upper list or menu to move to another menu, which causes an inconvenience for the user. Moreover, for the selection of menus during multitasking, the user needs to switch screens several times inconveniently.

Therefore, a need exists for an apparatus and method for easily controlling menus of a media device using a graphical user interface.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for easily controlling menus of a media device using a graphical user interface.

These and other aspects of the present invention will be apparent from the following description of exemplary embodiments of the present invention.

In accordance with an aspect of the present invention, a method for controlling a menu in a media device is provided. The method includes, if a first icon in a first icon group including a plurality of icons is pressed, changing a display status of remaining icons in the first icon group except for the first icon, displaying, in a set display area, a second icon group including at least one icon related to a function corresponding to the first icon, and if a second icon in the second icon group is selected due to a drag of the first icon, which is performed while the first icon is pressed, performing a function corresponding to the second icon.

In accordance with another aspect of the present invention, an apparatus for controlling a menu in a media device is provided. The apparatus includes a touch screen capable of inputting and displaying information, and a controller for, if a first icon in a first icon group including a plurality of icons is pressed, changing a display status of remaining icons in the first icon group except for the first icon, displaying a second icon group including at least one icon related to a function corresponding to the first icon, in a set display area on the touch screen, and if a second icon in the second icon group is selected due to a drag of the first icon, which is performed while the first icon is pressed, performing a function corresponding to a second icon which is the selected icon.

In accordance with another aspect of the present invention, a processor-readable recording medium storing a program for executing a method is provided. The method includes, if a first icon in a first icon group including at least one icon is pressed, changing a display status of remaining icons in the first icon group except for the first icon, displaying, in a set display area, a second icon group including at least one icon related to a function corresponding to the first icon, and if a second icon in the second icon group is selected due to a drag of the first icon, which is performed while the first icon is pressed, performing a function corresponding to the second icon.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart showing a method for controlling menus according to an exemplary embodiment of the present invention;

FIGS. 2A to 2N show screens displayed during execution of a menu control operation according to exemplary embodiments of the present invention;

FIG. 3 shows a Message Sequence Chart (MSC) according to an exemplary embodiment of the present invention; and

FIG. 4 shows a structure of a menu control apparatus according to an exemplary embodiment of the present invention.

Throughout the drawings, it should be noted that like reference numerals are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As described above, in a method for controlling menus of media devices of the related art, a user needs to find where his/her desired specific menu is located, and needs to switch screens several times. These requirements result in an inconvenience for the user.

To address this inconvenience, exemplary embodiments of the present invention provide an apparatus and method for easily controlling menus of media devices using a Graphical User Interface (GUI), especially icons.

The principle of operation according to an exemplary embodiment of the present invention may be summarized as follows.

In an exemplary embodiment of the present invention, two icon groups are used. One icon group (e.g., a first icon group) includes at least one icon for performing different functions, and another icon group (e.g., a second icon group) includes icons related to each of the icons in the first icon group, e.g., includes icons for performing sub-functions. In other words, each of the icons in the first icon group has a second icon group related to its functions.

Upon request from a user, a media device displays the first icon group. Thereafter, if the user selects any one icon (e.g., a first icon) in the first icon group, the media device changes the display status of the remaining icons in the first icon group except for the first icon, and displays the second icon group related to the first icon. The phrase ‘changing the display status of the remaining icons’ as used herein may refer to stopping the display of the remaining icons or setting the opacity of the remaining icons to be lower than that of the first icon, to thereby distinguish them from the first icon.

Thereafter, if any one icon (e.g., a second icon) in the second icon group is selected due to a drag of the first icon, the media device performs a function corresponding to the second icon.

With the above-described exemplary embodiment of the present invention, it is possible to easily control menus of a media device using icons without the need to switch screens several times.

The above-described principle of operation is a mere summary of an exemplary embodiment of the present invention, and the present invention is not limited thereto.

In the following description of exemplary embodiments of the present invention, the media device is assumed to have a touch screen. However, the present invention may be applied not only to media devices having a touch screen, but also to any other device on which images being displayed may be dragged.

The term ‘media device’ as used herein refers to a device capable of performing any one of recording, displaying, and playing media, and may be construed to include a mobile phone, a smart phone, a navigation terminal, a Personal Digital Assistant (PDA), a Portable Multimedia Player (PMP), a Moving Picture Experts Group layer 3 (MP3) player, a game console, a tablet computer, a netbook computer, a desktop computer, a notebook computer, a communication terminal capable of accessing the Internet, a communication terminal capable of receiving broadcast, etc.

The term ‘media’ as used herein refers to media containing certain information, and may be construed to include texts, audios, images, animations, videos, etc.

Exemplary embodiments of the present invention will be described below with reference to the accompanying drawings.

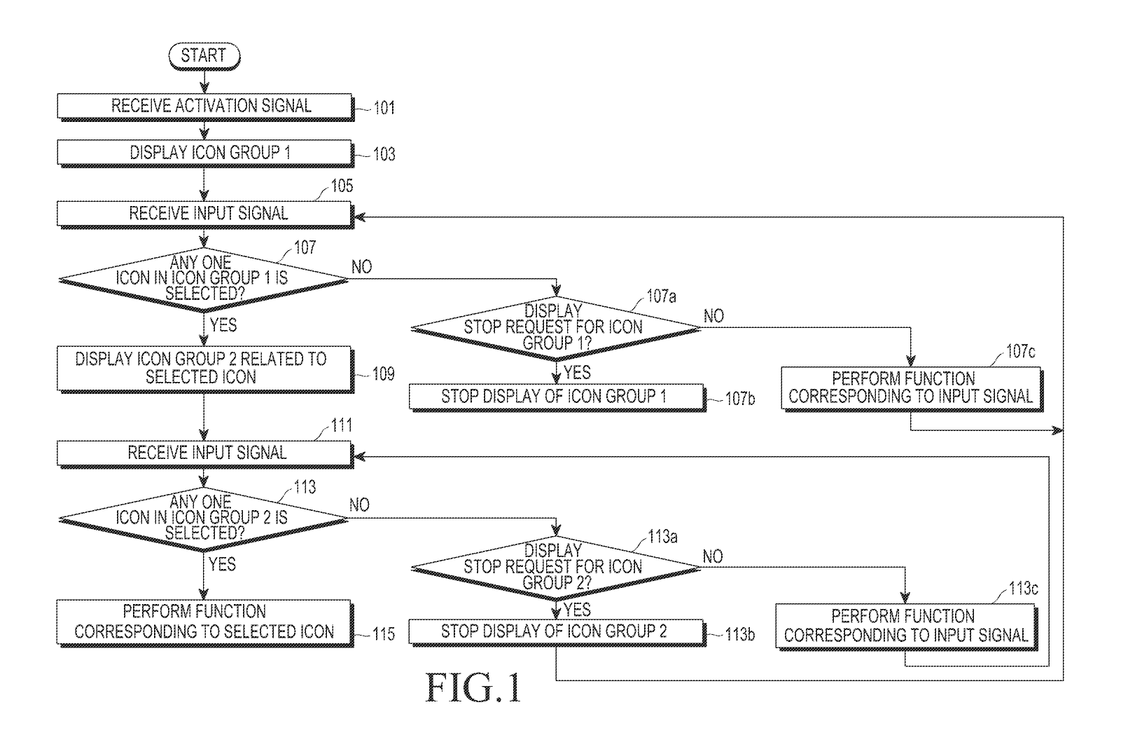

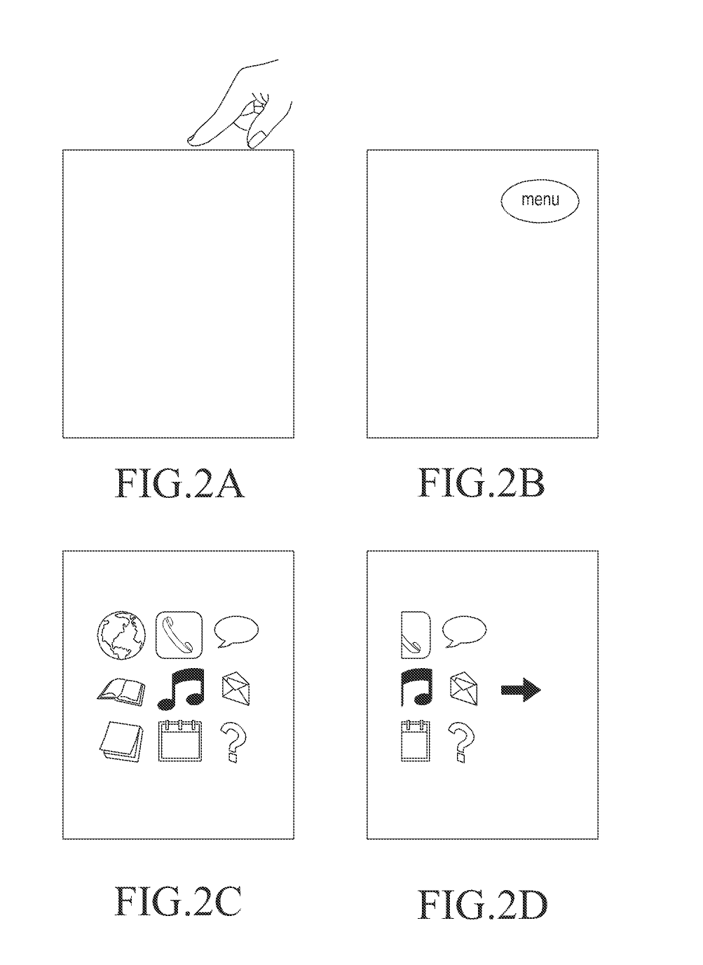

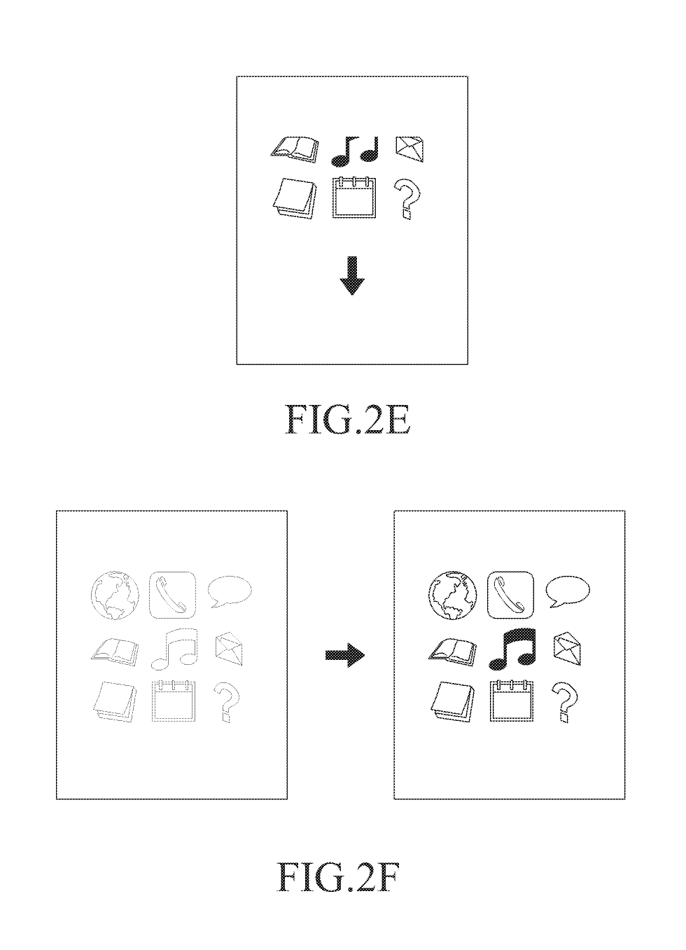

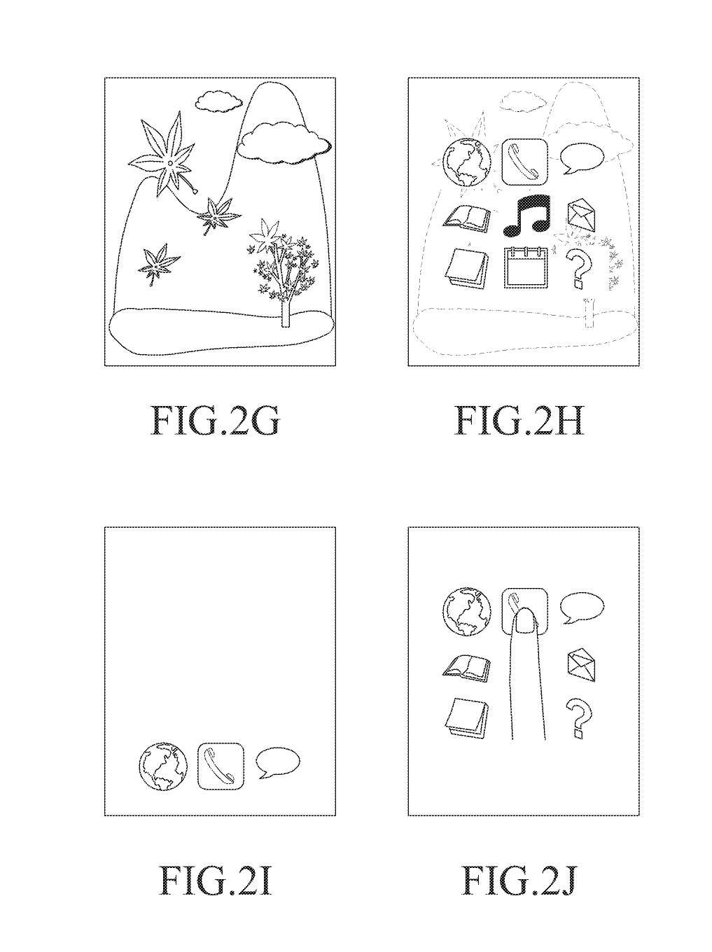

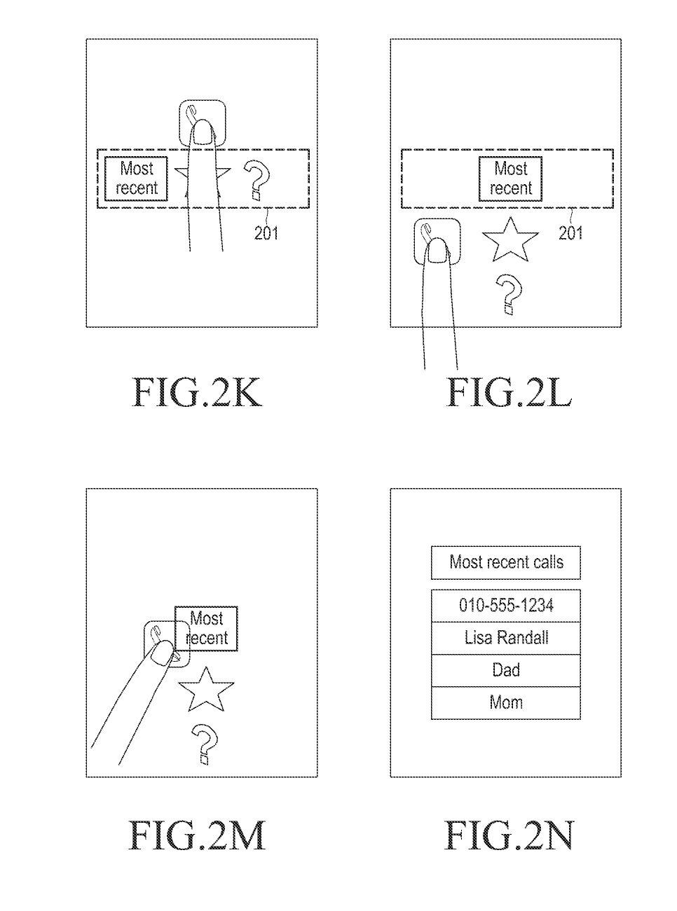

A menu control method according to an exemplary embodiment of the present invention will be described in detail with reference to FIGS. 1 and 2A to 2N.

FIG. 1 is a flowchart showing a method for controlling menus according to an exemplary embodiment of the present invention, and FIGS. 2A to 2N show screens displayed during execution of a menu control operation according to exemplary embodiments of the present invention.

Referring to FIG. 1, upon receiving a set activation signal in step 101, a media device displays a set first icon group in a set display area in step 103.

The term ‘activation signal’ as used herein may refer to a signal for requesting to display a first icon group in a set display area. In an exemplary embodiment, the activation signal may be generated in response to an action in which a user touches one side of the media device as shown in FIG. 2A, or may be generated when a specific icon located in a specific display area is selected by the user as shown in FIG. 2B. FIG. 2C shows an example of the first icon group, which is displayed upon receiving the activation signal.

The term ‘one side of the media device’ as used herein may refer to a predetermined area of the appearance of the media device, such as the media device's front, rear, upper side, lower side, left side, and right side.

As described above, the first icon group includes at least one icon for performing different functions. In an exemplary embodiment, different icons in the first icon group may correspond to different categories. For example, the categories may include an Internet-related category, a call-related category, a message-related category, an e-Book related category, an audio-related category, a video-related category, a mail-related category, a text-related category, a schedule-related category, a help-related category, etc. The categories may be set and changed by designers or users.

When displaying the first icon group, the media device may slide the first icon group from one side of the set display area and fix it in the set display area as shown in FIGS. 2D and 2E, or may gradually increase the opacity of the first icon group within a set range as shown in FIG. 2F, making it possible to provide the visual effects to the user.

When displaying the first icon group, the media device may hierarchically display the first icon group on the screen where the user was working. In this case, the media device may set the opacity of the first icon group to be higher than that of the screen where the user was working, making it possible to prevent the user from feeling a sense of disconnection between the current screen and the screen where he/she was working. FIG. 2G shows an example of the screen where the user was working, and FIG. 2H shows an example of a displayed screen on which the opacity of the first icon group is set to be higher than that of the screen where the user was working.

Steps 101 and 103 may be omitted depending on the intention of the designers or users of the media device. For example, the designers or users of the media device may set the first icon group to be always displayed in a predetermined display area as shown in FIG. 21. In this case, steps 101 and 103 may be omitted.

Upon receiving a predetermined signal in step 105, the media device determines in step 107 whether the signal received in step 105 is a signal for selecting any one icon in the first icon group. If the received signal is a signal for selecting any one icon in the first icon group, the media device proceeds to step 109. Otherwise, the media device proceeds to step 107a.

In an exemplary embodiment, the phrase ‘selecting any one icon in the first icon group’ as used herein may refer to a user's press action on any one icon in the first icon group as shown in FIG. 2J. The term ‘press action’ as used herein may refer to an action in which a user presses an area in which a predetermined icon is displayed in a display area, using his/her fingertip or the like. Herein, if ‘a release action after a press action’ or ‘an end of a press action’ is not described, it means that the press action continues. The ‘release action’ and the ‘end of a press action’ may be used herein to have the same meaning.

In step 109 (i.e., if the received signal is a signal for selecting any one icon in the first icon group), the media device changes the display status of the remaining icons in the first icon group except for the icon (i.e., a first icon) selected from the first icon group, and displays a second icon group related to the first icon, in a set display area. The phrase ‘changing the display status of the remaining icons in the first icon group’ as used herein may refer to stopping the display of the remaining icons or setting the opacity of the remaining icons to be lower than that of the first icon, to thereby distinguish them from the first icon. FIG. 2K shows an example of displaying the second icon group while stopping the display of the remaining icons in the first icon group.

In accordance with an exemplary embodiment, if the first icon group is set to be always displayed in a predetermined display area as described with reference to, for example, steps 101 and 103, even though a first icon is selected, the media device may display the second icon group without changing the display status of the first icon group.

In an exemplary embodiment, when displaying the second icon group, the media device may arrange the second icon group to be adjacent to the first icon, and if the second icon group has a plurality of icons, the media device may display the second icon group taking into account the frequency of the use of icons in the second icon group. For example, the most frequently used icon among the icons in the second icon group may be arranged closest to the first icon.

If the first icon is located on the top of the set display area as shown, for example, in FIG. 2K, the second icon group may be located at the bottom of the first icon. In this case, the user may have difficulty in viewing the second icon group which is hidden by his/her finger. Accordingly, if the first icon is moved to an area other than a display area 201 of the second icon group due to a drag of the first icon during the display of the second icon group, and a press action lasts for a set time or more, then the media device rearranges icons in the second icon group depending on a set method, as shown in FIG. 2L. The phrase ‘rearranging icons in the second icon group depending on a set method’ as used herein may refer to sequentially arranging icons in the second icon group, for example, from the top or the left of the set display area.

In an exemplary embodiment, the second icon group and the first icon group have a hierarchical relationship. In other words, icons in the second icon group are icons in a sub layer for the first icon. For example, if the first icon corresponds to a call-related category, the second icon group may be associated with call-related functions in its sub layer, such as displaying a recent call list, displaying a most frequent call list, displaying an address book, and displaying call-related help.

If a predetermined signal is received in step 111 after the second icon group is displayed, the media device determines in step 113 whether the signal received in step 111 is a signal for selecting any one icon in the second icon group. If the received signal is a signal for selecting any one icon in the second icon group, the media device proceeds to step 115. Otherwise, the media device proceeds to step 113a.

In an exemplary embodiment, the phrase ‘selecting any one icon in the second icon group’ as used herein may refer to the user's dragging of the first icon to any one icon in the second icon group, or the user's ending of a press action after dragging the first icon to any one icon in the second icon group.

The term ‘dragging’ as used herein may refer to the user's moving or shifting of an icon to another position while continuing a press action on the icon, and if ‘a release action after a drag action’ or ‘an end of a drag action’ is not described, it means that the press action continues.

The media device may determine whether any one icon in the second icon group is selected based on a set threshold. For example, in a case where the user selects any one icon in the second icon group only with a drag action, the media device may determine that any one icon in the second icon group is selected, when the area, in which a display area of the first icon overlaps a display area of any one icon in the second icon group, is greater than or equal to a set threshold, or when the distance between a display area of the first icon and a display area of any one icon in the second icon group is less than or equal to a set threshold.

The media device releases the selection of the first icon, if the press action on the first icon is ended before any one icon in the second icon group is selected. In this case, the media device restores the display status of icons, whose display status was changed, to their original display status which was set before the press action on the first icon occurred. Therefore, the user may select again the first icon.

In step 115 (i.e., if the received signal is a signal for selecting any one icon in the second icon group), the media device performs a function corresponding to any one icon (or a second icon) selected from the second icon group.

FIG. 2M shows an example of selecting a recent call list as a second icon, and FIG. 2N shows an example of displaying a recent call list by performing a function upon selection of the second icon.

While the first icon group is displayed, the user may desire to stop the display of the first icon group and return to the screen where he/she was working, or the user may desire to receive an incoming call. An operation performed in this case by the media device will be described with reference to steps 105 to 107c.

In step 107a (i.e., if the signal received in step 105 is not a signal for selecting any one icon in the first icon group), the media device determines whether the received signal is a signal for requesting to stop the display of the first icon group. It may be a case where the user desires to stop the display of the first icon group and return to the screen where he/she was working. The signal for requesting to stop the display of the first icon group may be generated, for example, by a press action on a specific icon (e.g., a Back icon) displayed together with the first icon group, or may be generated in response to the user's action that is detected at one side of the media device, similar to the activation of the first icon group.

If the received signal is determined as a signal for requesting to stop the display of the first icon group, the media device stops the display of the first icon group and returns to the screen where the user was working, in step 107b.

If the received signal is not determined as a signal for requesting to stop the display of the first icon group, the media device performs a function corresponding to the received signal in step 107c. The received signal may be, for example, a user's input signal for requesting a call connection for an incoming call. While performing the function corresponding to the received signal, the media device may continue the display of the first icon group, or may display a screen related to the received signal and then display again the first icon group when the execution of the function ends.

After performing the function corresponding to the received signal, for example, if the user receives an incoming call and then ends the call, the media device returns to step 105 and continues to perform an operation in response to a new input signal.

While the second icon group is displayed, the user may desire to stop the display of the second icon group and view again the first icon group. For example, the user may desire to select again an icon if he/she selected an undesired icon from the first icon group. Otherwise, the user may desire to answer an incoming call, which is received during the display of the second icon group. An operation performed by the media device in this case will be described with reference to steps 111 to 113c.

In step 113a (i.e., if the signal received in step 111 is not determined as a signal for selecting any one icon in the second icon group), the media device determines whether the received signal is a signal for requesting to stop the display of the second icon group. The signal for requesting to stop the display of the second icon group may be generated, for example, if the press action on the first icon is ended or released before any one icon in the second icon group is selected.

If the received signal is determined as a signal for requesting to stop the display of the second icon group, the media device stops the display of the second icon group and displays the first icon group or returns to the screen where the user was working before the display of the first icon group, in step 113b.

If the received signal is not determined as a signal for requesting to stop the display of the second icon group, the media device performs a function corresponding to the received signal in step 113c. The received signal may be, for example, a user's input signal for requesting a call connection for an incoming call. After performing the function corresponding to the received signal, the media device may display again the first icon group.

After performing the function corresponding to the received signal, for example, if the user receives an incoming call and then ends the call, the media device returns to step 105 and continues to perform an operation in response to a new input signal.

The first icon group and the second icon group may be set by the user, and may be automatically updated. For example, the media device may automatically update the first icon group and the second icon group based on the frequency of use by the user. For example, if icons in a non-first icon group are higher than any one icon in the first icon group in terms of the frequency of the use by the user, the media device may set the icons as a first icon group. The second icon group may also be updated in the same way. When updating the first icon group and the second icon group upon request of the user, the media device provides information related to selection and deletion of icons in an icon list to the user as a guide.

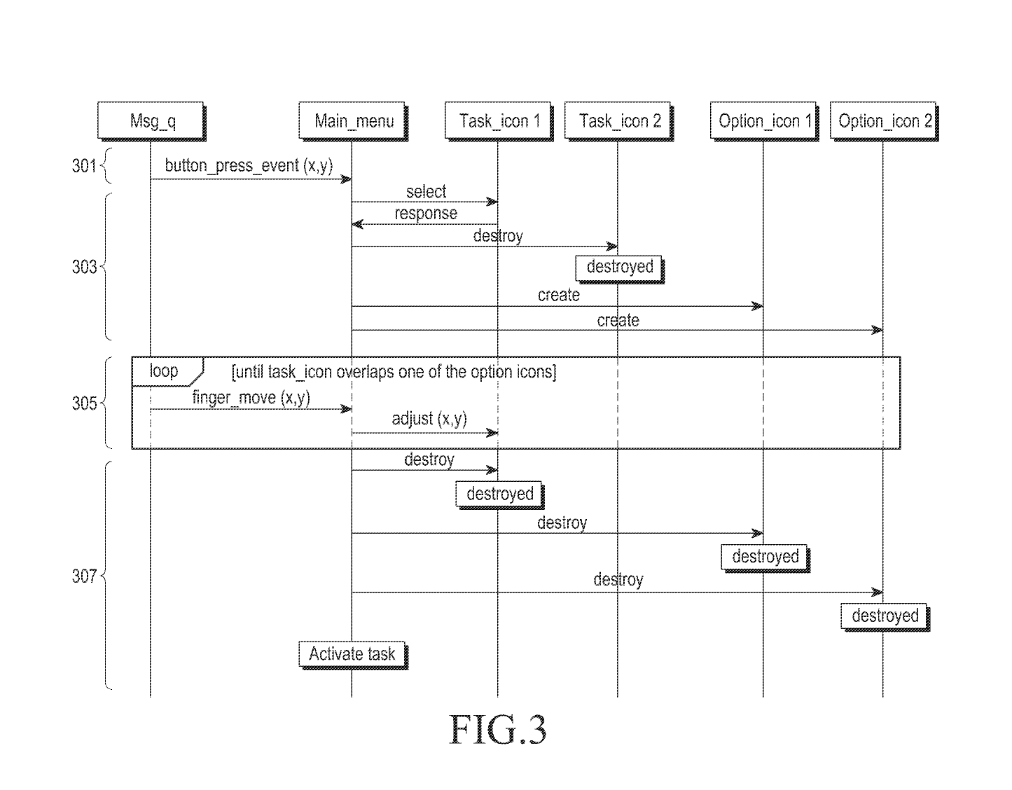

The menu control method according to an exemplary embodiment of the present invention has been described so far with reference to FIGS. 1 and 2A to 2N. A software operation of FIG. 1 will be described in more detail below with reference to FIG. 3.

FIG. 3 shows a Message Sequence Chart (MSC) according to an exemplary embodiment of the present invention. More specifically, FIG. 3 shows a typical example as to how the entities react during the execution of steps 105, 107, 109, 111, 113, and 115, which have been described with reference to FIG. 1.

Referring to FIG. 3, msg_q represents a message queue of the Operating System (OS), main_menu represents a graphical user interface containing task_icon, task_icon 1 and task_icon 2 represent icons in a first icon group, and option_icon (i.e., option_icon 1 and option_icon 2) represents icons in a second icon group.

In step 301, if a user performs a press action in a set display area, button_press_event is delivered to main_menu through message_queue of the OS together with position information of the display area where the press action has been performed.

In step 303, main_menu determines which task_icon is selected, based on the received position information, and removes all task_icons other than the selected task_icon. In other words, non-selected task_icons are no longer displayed. In the example of FIG. 3, task_icon 1 is selected, so non-selected task_icon 2 disappears from the set display area. However, in an alternative exemplary embodiment, it is possible to differentiate the opacity of task_icon 2 from that of task_icon 1 to distinguish between them, instead of removing task_icon 2 as described above. Thereafter, main_menu generates option_icons related to task_icon 1, for example, option_icon 1 and option_icon 2.

In step 305, if the user drags task_icon 1 in the set display area, position coordinates of task_icon 1 are changed based thereon. The information related to the change in coordinates is delivered from message_queue to main_menu, and main_menu changes the display position for task_icon 1 based on the received information. This operation continues until a press action on task_icon 1 is ended after task_icon 1 overlaps any one option_icon by a set threshold or task_icon 1 gets close to any one option_icon by a set threshold.

Thereafter, in step 307, if any one option_icon is selected, main_menu removes the displayed icons, i.e., task_icon 1, option_icon 1, and option_icon 2. Therefore, the icons are no longer displayed, and main_menu performs a function corresponding to the selected option_icon.

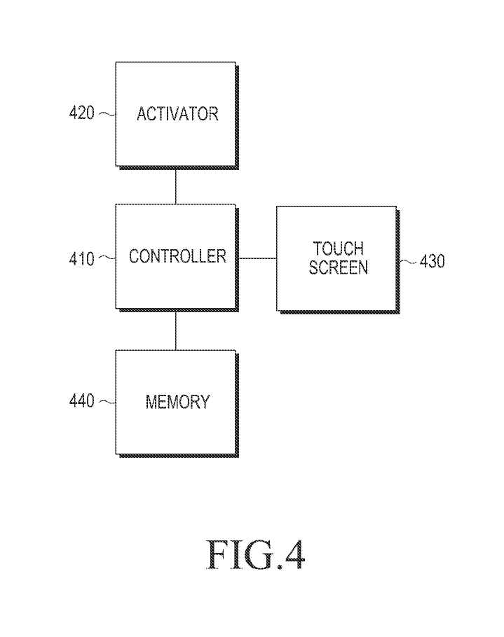

The menu control method according to an exemplary embodiment of the present invention has been described in brief so far with reference to MSC. A menu control apparatus according to an exemplary embodiment of the present invention will be described below with reference to FIG. 4.

FIG. 4 shows a structure of a menu control apparatus according to an exemplary embodiment of the present invention.

Referring to FIG. 4, the menu control apparatus includes a controller 410, an activator 420, a touch screen 430, and a memory 440.

Upon receiving an activation signal for requesting display of a first icon group, the controller 410 displays a first icon group in a set display area. During the display of the first icon group, the controller 410 may slide the first icon group from one side of the set display area and fix it in the set display area. Otherwise, the controller 410 may gradually increase the opacity of the first icon group within a set range in the set display area.

During the display of the first icon group, the controller 410 may hierarchically display the first icon group on the screen where the user was working. In this case, the controller 410 may set the opacity of the first icon group to be higher than that of the screen where the user was working. In accordance with an exemplary embodiment, the first icon group may always be displayed in a predetermined display area regardless of the activation signal.

Upon receiving a signal for requesting to stop the display of the first icon group during the display of the first icon group, the controller 410 stops the display of the first icon group and then returns to the screen where the user was working.

Upon receiving a specific signal (e.g., a signal for requesting a call connection for an incoming call) during the display of the first icon group, the controller 410 performs a function corresponding to the specific signal. While performing the function corresponding to the specific signal, the controller 410 may continue the display of the first icon group, or may display a screen associated with the specific signal and then display again the first icon group when the execution of the function ends.

If any one icon in the first icon group is selected, the controller 410 changes the display status of the remaining icons in the first icon group except for the first icon which is the selected icon, and displays a second icon group associated with the first icon. However, in accordance with an exemplary embodiment, the controller 410 may not change the display status of the first icon group even though the first icon is selected.

During the display of the second icon group, the controller 410 may arrange the second icon group to be adjacent to the first icon. The controller 410 may display the second icon group taking into account the frequency of the use of icons in the second icon group. For instance, the controller 410 may arrange the most frequently used icon among the icons in second icon group, to be closest to the first icon.

During the display of the second icon group, if the first icon is moved to an area other than the display area of the second icon group and a press action lasts for a set time or more, the controller 410 may rearrange icons in the second icon group depending on a set method.

If the first icon is dragged to any one icon in the second icon group, or if a press action is ended after the first icon is dragged to any one icon in the second icon group, the controller 410 performs a function corresponding to a second icon, which is the selected icon, determining that the any one icon is selected.

The controller 410 may determine whether any one icon in the second icon group is selected, based on a set threshold, for example, the area in which icons overlap each other, or the minimum distance between the icons.

Upon receiving a signal for requesting to stop the display of the second icon group during the display of the second icon group, the controller 410 stops the display of the second icon group, and displays the first icon group or returns to the screen where the user was working before the display of the first icon group.

Upon receiving a specific signal (e.g., a signal for requesting a call connection for an incoming call) during the display of the second icon group, the controller 410 performs a function corresponding to the specific signal. After performing the function corresponding to the specific signal, the controller 410 may display again the first icon group.

The controller 410 may update the first icon group and the second icon group upon request of the user or automatically. The controller 410 may update the first icon group and the second icon group automatically, based on the frequency of the use by the user. For example, if icons in a non-first icon group are higher than any one icon in the first icon group in terms of the frequency of the use by the user, the media device may set the icons as a first icon group. The second icon group may also be updated in the same way. When updating the first icon group and the second icon group upon request of the user, the controller 410 provides a guide on the touch screen 430 to allow the user to select and delete icons.

The activator 420, located in at least one side of the media device, generates an activation signal upon request of a user desiring to display the first icon group and delivers the activation signal to the controller 410. In accordance with an exemplary embodiment, the activation signal may be generated in a predetermined display area. For example, if a specific icon being displayed in a predetermined display area is selected, the touch screen 430 may generate an activation signal and deliver it to the controller 410. In this case, the activator 420 may be omitted.

The touch screen 430, under control of the controller 410, displays various kinds of images including the first icon group and the second icon group, detects a user's press action, drag action and release action, and outputs the detected information to the controller 410.

The memory 440 stores the information related to the first icon group and the second icon group. The information related to the first icon group and the second icon group may be, for example, types of icons in the first icon group and the second icon group, and the frequency of the use of the icons. The memory 440 may also store various contact information, call-related information, schedule-related information, text data, audio data, video data, etc.

The above-described exemplary embodiments of the present invention may be implemented in various ways. For example, exemplary embodiments of the present invention may be implemented using hardware, software, or a combination thereof When implemented in software, exemplary embodiments of the present invention may be implemented as software that runs in at least one processor, which uses a variety of operating systems or platforms. In addition, such software may be created using any of a number of suitable programming languages, and may be complied into machine code or intermediate code which may be executed in a framework or a virtual machine.

When exemplary embodiments of the present invention are implemented in more than one processor, they may be implemented in a processor-readable medium (e.g., memories, floppy disks, Compact Disks (CDs), optical disks, magnetic tapes, etc.) storing more than one program for executing the method for implementing the above-described various exemplary embodiments of the present invention.

As is apparent from the foregoing description, the present invention makes it possible to more easily control menus of a media device.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling a menu in a media device, the method comprising:
if a first icon in a first icon group including a plurality of icons is pressed, changing a display status of remaining icons in the first icon group except for the first icon;
displaying, in a set display area, a second icon group including at least one icon related to a function corresponding to the first icon; and
if a second icon in the second icon group is selected due to a drag of the first icon, which is performed while the first icon is pressed, performing a function corresponding to the second icon.

2. The method of claim 1, further comprising displaying the first icon group in the set display area, if a signal requesting activation of the first icon group is received before the first icon is pressed.

3. The method of claim 2, wherein the displaying of the first icon group comprises at least one of displaying the first icon group such that the first icon group is slid from one side of the set display area and fixed in the set display area and displaying the first icon group such that an opacity of the first icon group gradually increases within a set range in the set display area.

4. The method of claim 2, wherein the displaying of the first icon group comprises hierarchically displaying the first icon group on a screen on which a user was working, the first icon group having a different opacity from that of the screen.

5. The method of claim 1, wherein the changing of the display status of the remaining icons comprises setting an opacity of the remaining icons in the first icon group to be lower than an opacity of the first icon.

6. The method of claim 1, further comprising restoring the display status of the remaining icons in the first icon group to the display status before the first icon is pressed, if the press on the first icon is ended before the second icon is selected.

7. The method of claim 1, wherein the displaying of the second icon group comprises arranging icons in the second icon group to be adjacent to the first icon.

8. The method of claim 1, wherein the displaying of the second icon group comprises displaying the second icon group corresponding to a frequency of use of icons in the second icon group.

9. The method of claim 1, wherein the displaying of the second icon group further comprises rearranging icons in the second icon group depending on a set method, if the first icon is moved to an area other than a display area of the second icon group due to a drag of the first icon and the first icon is continuously pressed for a set time or more.

10. The method of claim 1, wherein the second icon comprises an icon that overlaps the first icon in terms of a display area by a set threshold or more when the press on the first icon is ended, or an icon that overlaps the first icon in terms of a display area by a threshold or more while the first icon is pressed.

11. The method of claim 1, wherein at least one of the first icon group and the second icon group is automatically updated corresponding to a frequency of use by a user, or manually updated by the user.

12. An apparatus for controlling a menu in a media device, the apparatus comprising:
a touch screen capable of inputting and displaying information; and
a controller for, if a first icon in a first icon group including a plurality of icons is pressed, changing a display status of remaining icons in the first icon group except for the first icon, displaying a second icon group including at least one icon related to a function corresponding to the first icon in a set display area on the touch screen, and, if a second icon in the second icon group is selected due to a drag of the first icon, which is performed while the first icon is pressed, performing a function corresponding to the second icon.

13. The apparatus of claim 12, wherein the controller displays the first icon group in the set display area upon receiving a signal requesting activation of the first icon group.

14. The apparatus of claim 13, wherein the controller controls the first icon group such that the first icon group is slid from one side of the set display area and fixed in the set display area, or controls the first icon group such that an opacity of the first icon group gradually increases within a set range in the set display area.

15. The apparatus of claim 13, wherein the controller hierarchically displays the first icon group on a screen on which a user was working, the first icon group having a different opacity from that of the screen.

16. The apparatus of claim 12, wherein the controller sets an opacity of the remaining icons in the first icon group to be lower than an opacity of the first icon, when changing the display status of the remaining icons in the first icon group.

17. The apparatus of claim 12, wherein the controller restores the display status of the remaining icons in the first icon group to the display status before the first icon is pressed, if the press on the first icon is ended before the second icon is selected.

18. The apparatus of claim 12, wherein the controller arranges icons in the second icon group to be adjacent to the first icon.

19. The apparatus of claim 12, wherein the controller arranges the second icon group corresponding to a frequency of use of icons in the second icon group.

20. The apparatus of claim 12, wherein the controller rearranges icons in the second icon group depending on a set method, if the first icon is moved to an area other than a display area of the second icon group due to a drag of the first icon and the first icon is continuously pressed for a set time or more.

21. The apparatus of claim 12, wherein the second icon comprises an icon that overlaps the first icon in terms of a display area by a set threshold or more when the press on the first icon is ended, or an icon that overlaps the first icon in terms of a display area by a threshold or more while the first icon is pressed.

22. The apparatus of claim 12, wherein the controller controls a function of providing a guide on the touch screen so that at least one of the first icon group and the second icon group is automatically updated corresponding to a frequency of use by a user, or manually updated by the user.
